(19) United States
(12) Patent Application Publication
(10) Pub. No.: US 2026/0109051 A1
(43) Pub. Date: Apr. 23, 2026

(54) ROBOT APPARATUS INCLUDING GRIPPER AND CONTROL METHOD THEREOF

(71) Applicant: SAMSUNG ELECTRONICS CO., LTD., Suwon-si (KR)

(72) Inventor: Eungpyo KIM, Suwon-si (KR)

(73) Assignee: SAMSUNG ELECTRONICS CO., LTD., Suwon-si (KR)

(21) Appl. No.: 19/397,294

(22) Filed: Nov. 21, 2025

Related U.S. Application Data
(63) Continuation of application No. PCT/KR2025/014423, filed on Sep. 16, 2025.

(30) Foreign Application Priority Data
Dec. 24, 2024 (KR) 10-2024-0195672
Oct. 18, 2024 (KR) 10-2024-0143387

(51) Int. Cl. B25J 15/00; B25J 9/16; B25J 15/02

(52) U.S. Cl. CPC B25J 15/0071; B25J 9/1612; B25J 9/1697; B25J 15/02

(57) ABSTRACT

A robot apparatus including a gripper is provided. The gripper includes a housing; a first driving part and a second driving part both inside the housing; a first needle and a second needle both configured to move in a first direction through an opening in the housing from the inside of the housing to an outside of the housing, , or to move from the outside of the housing to the inside of the housing in a second direction opposite to the first direction, based on an operation of the first driving part; and a first adjustment block and a second adjustment block, both in the opening of the housing and both configured to move toward each other or away from each other based on an operation of the second driving part, wherein the first needle and the second needle are curved toward one another and are configured to grip an item by intersecting with each other as the first needle and the second needle interfere with the first adjustment block and the second adjustment block as the first driving part causes the first needle and the second needle to move in the first direction.

### CROSS-REFERENCE TO RELATED APPLICATIONS

This application is a by-pass continuation of International Application No. PCT/KR2025/014423, filed on September 16, 2025, which is based on and claims priority to Korean Patent Application No. 10-2024-0143387, filed in the Korean Intellectual Property Office on October 18, 2024, and Korean Patent Application No. 10-2024-0195672, filed in the Korean Intellectual Property Office on December 24, 2024, the disclosures of which are incorporated by reference herein in their entireties.

### BACKGROUND

### 1. Field

The present disclosure relates to a robot apparatus including a gripper for gripping items, such as food, and a control method thereof.

### 2. Description of Related Art

As technology advances, robot technology is being utilized in various fields to replace human labor. In particular, the robot apparatus is being developed in fields that require delicate and sophisticated work, such as factories, construction, medical sites, and aerospace. However, a conventional robot apparatus has limitations in accurately gripping small items such as food.

### SUMMARY

According to an aspect of the disclosure, a gripper includes: a housing; a first driving part and a second driving part both inside the housing; a first needle and a second needle both configured to move in a first direction through an opening in the housing from the inside of the housing to an outside of the housing, , or to move from the outside of the housing to the inside of the housing in a second direction opposite to the first direction, based on an operation of the first driving part; and a first adjustment block and a second adjustment block, both in the opening of the housing and both configured to move toward each other or away from each other based on an operation of the second driving part, wherein the first needle and the second needle are curved toward one another and are configured to grip an item by intersecting with each other as the first needle and the second needle interfere with the first adjustment block and the second adjustment block as the first driving part causes the first needle and the second needle to move in the first direction.

According to an aspect of the disclosure, a robot apparatus includes: a robot arm comprising a plurality of joints; a gripper including a first driving motor, a first needle, and a second needle, wherein the first needle and the second needle are each connected to an end of the robot arm and are curved toward each other; an image sensor configured to obtain an image of a target contained in a container; memory storing at least one instruction and further storing information on a reference signal pattern corresponding to a target gripping process; and at least one processor configured to individually or collectively execute the at least one instruction, wherein the at least one instruction, when executed by the at least one processor individually or collectively, causes the robot apparatus to: identify the target to be gripped based on the image, control the gripper to grip the identified target using the first needle and the second needle by controlling the first driving motor to cause the first needle and the second needle to move in a first direction from an inside of the gripper toward an outside of the gripper, and based on a change pattern of an electrical signal corresponding to a load applied to the first driving motor during the target gripping process not matching the reference signal pattern, control the gripper to grip the identified target again by controlling the first driving motor to cause the first needle and the second needle to move in a second direction from the outside of the gripper toward the inside of the gripper, and then controlling the first driving motor to cause the first needle and the second needle to move in the first direction from the inside of the gripper toward the outside of the gripper.

According to an aspect of the disclosure, a method of controlling a robot apparatus including a gripper, includes: identifying a target based on an image of the target; controlling a first needle included in the gripper and a second needle included in the gripper to grip the identified target; identifying a change pattern of an electrical signal corresponding to a load applied to a driving motor of the gripper during the driving of the first needle and the second needle, wherein the driving motor drives the first needle and the second needle; and based on a previously stored reference signal pattern and the identified change pattern of the electrical signal not matching, controlling the first needle and the second needle to grip the target again.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram showing a robot apparatus according to an embodiment of the present disclosure;

FIG. 2 is a side view showing the robot apparatus according to an embodiment of the present disclosure;

FIG. 3 is a plan view showing the robot apparatus according to an embodiment of the present disclosure;

FIG. 4 is a perspective view showing a gripper according to an embodiment of the present disclosure;

FIG. 5 is a bottom view showing the gripper according to an embodiment of the present disclosure;

FIG. 6 is a cross-sectional view taken along line A-A’ shown in FIG. 5;

FIG. 7 is a cross-sectional view taken along line B-B’ shown in FIG. 5;

FIG. 8 is a perspective view showing the inside of the gripper according to an embodiment of the present disclosure;

FIG. 9 is a side view showing the gripper shown in FIG. 8;

FIG. 10 is a flowchart schematically showing a control method of a robot apparatus according to an embodiment of the present disclosure;

FIG. 11 is a flowchart showing the control method of a robot apparatus according to an embodiment of the present disclosure;

FIGS. 12, 13, and FIG. 14 are diagrams showing examples of controlling the gripper of the robot apparatus according to an embodiment of the present disclosure to grip an item from a container and drop the item into a target container; and

FIG. 15 is a graph showing a change in a movement speed of a needle and a change in a current according to a control step of the robot apparatus according to an embodiment of the present disclosure.

In describing the drawings, the same or similar components are denoted by the same or similar reference numerals.

### DETAILED DESCRIPTION

The present disclosure may be variously modified and have several embodiments, and specific embodiments of the present disclosure are thus illustrated in the accompanying drawings and described in detail in this specification. However, it should be understood that the scope of the present disclosure are not limited to specific embodiments, and include all modifications, equivalents, and alternatives according to at least one embodiment of the present disclosure. Throughout the accompanying drawings, similar components are denoted by similar reference numerals.

The present disclosure omits a detailed description of known functions or configurations where such a detailed description may unnecessarily obscure the gist of the present disclosure. In addition, at least one embodiment of the present disclosure may be modified in several different forms, and the scope and spirit of the present disclosure are not limited to the following embodiments. Rather, these embodiments make the present disclosure thorough and complete, and are provided to completely convey the spirit of the present disclosure to those skilled in the art.

Terms used in the present disclosure are used only to describe the specific embodiments rather than limit the scope of the present disclosure. A term of a singular number may include its plural number unless explicitly indicated otherwise in the context.

In the present disclosure, the expression “have”, “may have”, “include”, “may include” or the like, indicates the presence of a corresponding feature (for example, a numerical value, a function, an operation, or a component such as a part), and does not exclude the presence of an additional feature.

In the present disclosure, the expression “A or B”, “least one of A and/or B” or “one or more of A and/or B” or the like may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

The expressions “first”, “second”, and the like used in the present disclosure may indicate various components regardless of the sequence and/or importance of the components. These expressions are only used to distinguish one component and another component from each other, and do not limit the corresponding components.

An expression “configured (or set) to” used in the present disclosure may be replaced by an expression “suitable for”, “having the capacity to”, “designed to”, “adapted to”, “made to” or “capable of” based on a context. The expression “configured (or set) to” may not necessarily indicate “specifically designed to” in hardware.

In the present disclosure, a “module” or a “part” may perform at least one function or operation, and be implemented by hardware or software or be implemented by a combination of hardware and software. In addition, a plurality of “modules” or a plurality of “parts” may be integrated in at least one module and be implemented by the processor except for a “module” or a “part” that needs to be implemented by specific hardware.

The various elements and areas in the drawings are schematically shown. Therefore, the spirit of the present disclosure is not limited by relative sizes or intervals shown in the accompanying drawings.

Hereinafter, at least one embodiment of the present disclosure is described in detail with reference to the accompanying drawings so that those skilled in the art to which the present disclosure pertains may practice the present disclosure.

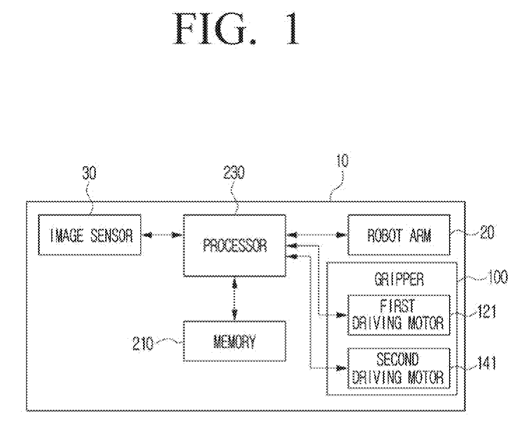

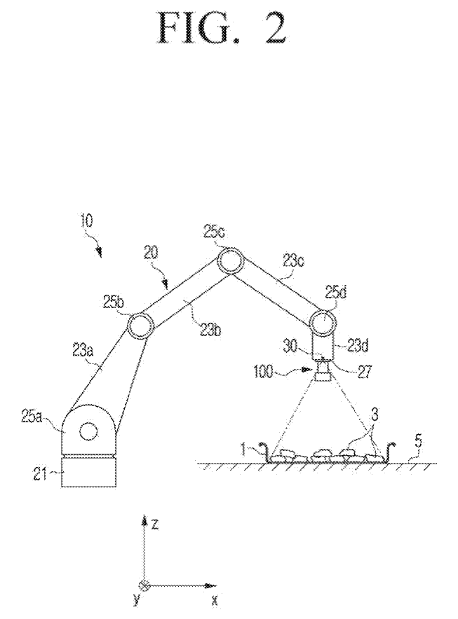

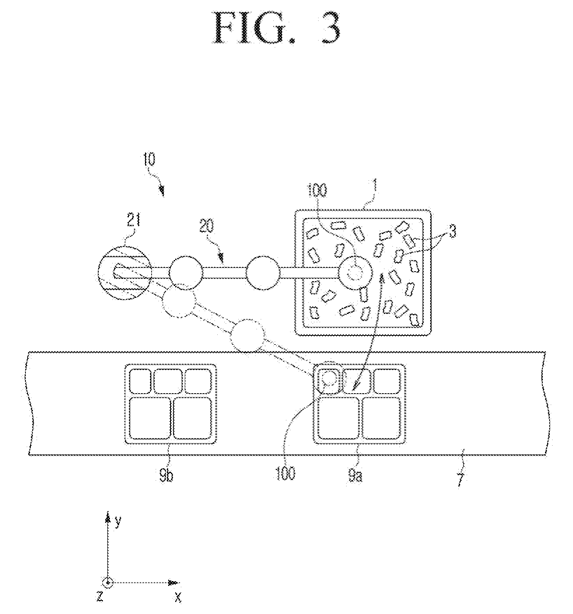

FIG. 1 is a block diagram showing a robot apparatus 10 according to an embodiment of the present disclosure; FIG. 2 is a side view showing the robot apparatus according to an embodiment of the present disclosure; and FIG. 3 is a plan view showing the robot apparatus according to an embodiment of the present disclosure.

Referring to FIGS. 1, 2 and 3, the robot apparatus 10 according to an embodiment may include a robot arm 20, an image sensor 30, a gripper 100, a memory 210, and a processor 230.

According to an embodiment, the robot arm 20 may be multi-axis actuatable to transport an item (e.g., a selected one among a plurality of items 3) contained in a container 1 to target containers 9a and 9b (e.g., trays or lunch boxes for sale). As an example, the items may be pieces of food. For example, the multi-axis actuation may include three-axis linear motions (e.g., X-axis linear motion, Y-axis linear motion, and Z-axis linear motion) and three-axis rotational motions (e.g., roll, pitch, and yaw motions).

According to an embodiment, the robot arm 20 may include a base 21, a plurality of links, and a plurality of joints. The plurality of links may include a first link 23a, a second link 23b, a third link 23c, and a fourth link 23d. The plurality of joints may include a first joint 25a connecting the base 21 to the first link 23a, a second joint 25b connecting the first link 23a to the second link 23b, a third joint 25c connecting the second link 23b to the third link 23c, and a fourth joint 25d connecting the third link 23c to the fourth link 23d.

According to an embodiment, the first joint 25a may be connected to a rotation axis of the base 21 (e.g., an axis parallel to a z-axis shown in FIG. 2) and may rotate clockwise or counterclockwise around the rotation axis of the base 21. A motor (e.g., a stepper motor) that may be driven in forward and backward rotations may be disposed inside each of the base 21, the first joint 25a, the second joint 25b, the third joint 25c, the fourth joint 25d and the fourth link 23d. The robot arm 20 shown in FIGS. 2 and 3 is described as including four links and four joints, but the disclosure is not limited thereto. The robot arm 20 may include a sufficient number of links and joints to enable an operation for transporting the items 3 contained in the container 1 to the target containers 9a and 9b. For example, the robot arm 20 may include at least three links and at least three joints for connecting the base to the three links.

According to an embodiment, the gripper 100 may be connected to a pivot part 27 disposed at a free end of the fourth link 23d. The pivot part 27 may include a step motor to rotate the gripper 100 forward or backward around a central axis of the fourth link 23d which corresponds to a length direction of the fourth link 23d (e.g., as shown in FIG. 2, a direction parallel to the z-axis).

According to an embodiment, the image sensor 30 may be disposed on the fourth link 23d. The image sensor 30 may be controlled by the processor 230 to obtain image information by capturing images of the plurality of items 3 contained in the container 1. For example, the image information may include the position coordinates, size, shape, or the like of each of the plurality of items 3.

According to an embodiment, the image sensor 30 may include a vision camera, a red-green-blue (RGB) camera (a color camera), a depth camera, a stereo camera, a light detection and ranging (LiDAR) sensor, an infrared camera, and/or a time of flight (ToF) camera. For example, the image sensor 30 may include the vision camera for obtaining a two-dimensional (2D) image, together with the depth camera or the LiDAR sensor for obtaining accurate height information if the plurality of items 3 overlap each other on the bottom of the container 1.

According to an embodiment, the gripper 100 may be controlled by the processor 230 to grip the item 3 contained in the container 1 and to drop the item 3 into a predetermined position within the determined target container 9a or 9b after moving to the target container 9a or 9b determined by the robot arm 20. For example, the container 1 may be seated on a worktable 5. The target container 9a or 9b may be seated on a conveyor device 7 disposed on one side of the worktable 5. The conveyor device 7 may be controlled by the processor 230 to transport or stop the target container 9a or 9b.

According to an embodiment, the memory 210 is a component including various programs, instructions, data, or the like required for the operation of the robot apparatus 10. The memory 210 may store at least one instruction. FIG. 1 shows that the memory 210 is separate from the processor 230, but the disclosure is not necessarily limited thereto. The memory 210 may be implemented as an internal memory such as a read only memory (ROM, for example, an electrically erasable programmable read-only memory (EEPROM)), a random access memory (RAM), or the like, included in the processor 230.

According to an embodiment, the memory 210 may be implemented in the form of a memory embedded in the robot apparatus 10 or in the form of a memory detachably attached to the robot apparatus 10, based on a purpose of data storage. For example, the memory 210 may be implemented in various forms, such as a volatile memory (e.g., a static RAM (SRAM) or a synchronous dynamic RAM (SDRAM)), a non-volatile memory (e.g., an one time programmable read only memory (OTPROM), a programmable ROM (PROM), an erasable and programmable ROM (EPROM), an electrically erasable and programmable ROM (EEPROM), a mask ROM, or a flash ROM), a flash memory, a hard drive, or a solid state drive (SSD), a compact flash (CF), a secure digital (SD), a micro secure digital (Micro-SD), a mini secure digital (Mini-SD), an extreme digital (xD), or a multi-media card (MMC)), or the like.

In the present disclosure, the term “memory 210” may be used as a concept including a storage, the ROM or the RAM, disposed inside the processor 230, or a memory card (e.g., the Micro-SD card or a memory stick) mounted in the robot apparatus. FIG. 1 shows one memory 210, but various numbers of memory 210 may be implemented.

According to an embodiment, the memory 210 is a component for storing at least one instruction, an operating system (O/S), a program, and data related to the robot apparatus 10. The memory 210 may be accessed by the processor 230. Reading, writing, modifying, deleting, updating, or the like of data by the processor 230 may be performed on the memory 210.

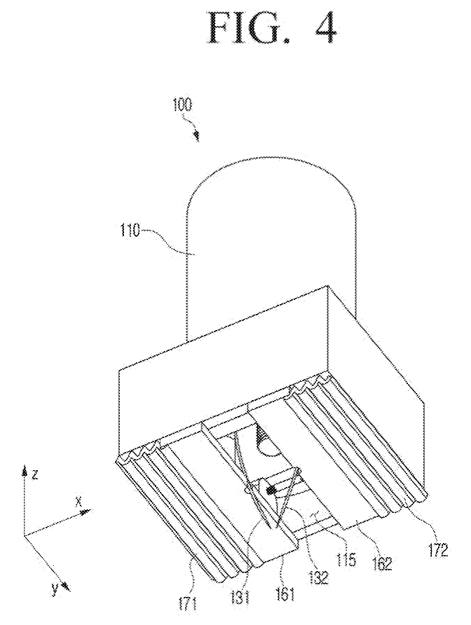

For example, the memory 210 may store various information, such as information on the image sensor 30, the image information obtained by the image sensor 30, characteristic information of the item, information on a first driving motor 121 and a second driving motor 141, information on a spacing between a first needle 131 (see FIG. 4) and a second needle 132 (see FIG. 4), and programs, instructions, or the like for controlling the operations of the robot apparatus 10 and other devices.

According to an embodiment, the memory 210 may store a plurality of pre-trained artificial intelligence models. For example, the artificial intelligence model may be implemented as a convolutional neural network (CNN), a long short-term memory (LSTM), a deep neural network (DNN), a recurrent neural network (RNN), a restricted Boltzmann machine (RBM), a deep belief network (DBN), a bidirectional recurrent deep neural network (BRDNN), or the like, and is not limited to such an example. The artificial intelligence model may be a computing system implemented by invoking neural networks of human or animal brains, and may be referred to as a learning model, a machine learning model, a neural network model, a deep learning model, or the like.

According to an embodiment, the memory 210 may store the artificial intelligence model trained to select a gripping depth that matches the characteristic information of the item (e.g., the stiffness, density, texture, or the like of a material included in the item). For example, the memory 210 may store a reference signal pattern corresponding to a load applied to the first driving motor 121 during a process of gripping the item 3 based on the characteristic information of the item. A manner of gripping the item 3 may be implemented as a form in which the first needle 131 (see FIG. 4) and the second needle 132 (see FIG. 4), included in the gripper 100, are inserted from a surface of the item 3 into the item 3. The load applied to the first driving motor 121 may occur in less than about one second, or about one to two seconds, in which the first needle 131 and the second needle 132 are inserted into the item 3. A current value indicates whether the load applied to the first driving motor 121 may be greater than an average current value while the first needle 131 and the second needle 132 move toward the item 3. The reference signal pattern stored in the memory 210 may correspond to the load (e.g., the current value) applied to the first driving motor 121 in a case where the item 3 is gripped.

According to an embodiment, the processor 230 may control overall operations of the robot apparatus 10. For example, the processor 230 may be coupled to a configuration of the robot apparatus 10 including the memory 210, and may control overall operations of the electronic apparatus by executing at least one instruction stored in the memory 210 as described above. In particular, the processor 230 may be implemented not only as one processor but also as a plurality of processors.

According to an embodiment, the processor 230 may be implemented as at least one integrated circuit (IC, or circuitry) chip and may process various data. The processor 230 may include at least one electrical circuitry and may individually or collectively distribute and process the instructions (or programs, data, or the like) stored in the memory.

According to an embodiment, the processor 230 may include a processor assembly including at least one processing circuitry. The processor 230 may include any processing circuitry operative to control the performance and operations of at least one component (e.g., the memory and/or an actuator (a motor or a sensor)) of the robot apparatus 10. For example, the processor 230 (e.g., an access point (AP)) may be implemented as a system on chip (SoC) (e.g., a single chip or a chipset). For example, the processor 230 may be implemented as multiple cores (or at least one core circuitry), multiple chips, or multiple chipsets.

For example, the processor 230 may include at least one processing circuitry. In addition, the processor 230 may include at least one processing circuitry for individually and/or collectively performing various functions in the present disclosure. As a non-limiting example, at least a portion of the processor 230 may be included in a first chip of the robot apparatus 10, and at least another portion of the processor 230 may be included in a second chip of the robot apparatus that is different from the first chip of the robot apparatus 10.

For example, the processor 230 may include a central processing unit (CPU), a graphics processing unit (GPU), a neural processing unit (NPU), an image signal processor (ISP), a display controller, a memory controller, a storage controller, a communication processor (CP), and/or a sensor interface. These components of the processor 230 are merely provided as examples. The processor 230 may further include other components in addition to the above-described components. In addition, some components of the processor 230 may be omitted. In addition, some components of the processor 230 may be included as separate components of the robot apparatus 10 disposed outside the processor 230. For example, some components of the processor 230 (e.g., the memory controller) may be included within other components (e.g., at least a portion of the memory, the interface (e.g., available for connection to at least one component of the robot apparatus 10), a display).

According to an embodiment, the processor 230 may cause other components of the robot apparatus 10 to perform various operations by executing instructions stored in the memory 210. The processor 230 may process setting values, function instructions, or the like based on a control program or control data stored in the memory 210, and output a control signal related to a function that the robot apparatus 10 may perform or a communication signal for communication with an external robot apparatus.

According to an embodiment, the processor 230 may control the operation of the robot arm 20 to set a position of the gripper 100 based on the image information obtained from at least one image sensors 30. For example, the image information may refer to the image information including the position coordinates, size, shape, or the like of each of the plurality of items 3 contained in the container 1.

According to an embodiment, the processor 230 may control the gripper 100 to grip one of the items 3 contained in the container 1, control the robot arm 20 to transport the item gripped by the gripper 100 to the target container 9a or 9b, and control the gripper 100 to drop the item 3 into the target container 9a or 9b.

According to an embodiment, the processor 230 may identify a change pattern of an electrical signal corresponding to the load applied to the first driving motor 121 that drives the gripper 100 during the process of gripping the item 3 by using the gripper 100. If the reference signal pattern stored in the memory 210 and the identified change pattern of the electric signal do not match each other, the processor 230 may control the first driving motor 121 to grip the item 3 again by using the gripper 100.

Hereinafter, a configuration of the gripper 100 included in the robot apparatus 10 according to an embodiment is described in detail with reference to the drawings. The gripper 100 may be controlled by the processor 230 to grip and drop the item 3.

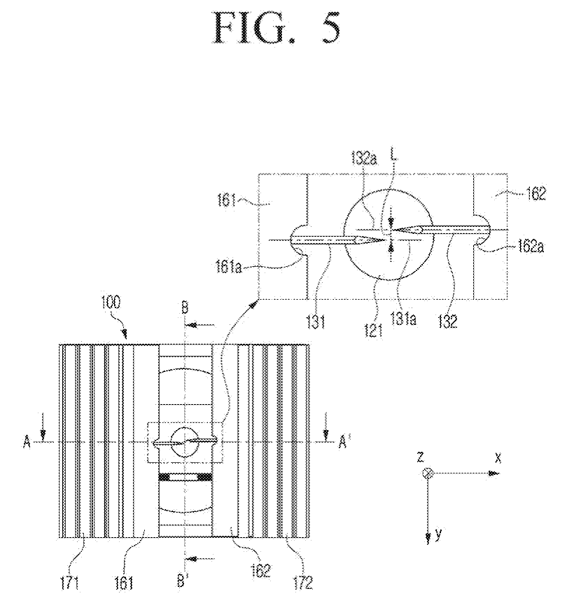

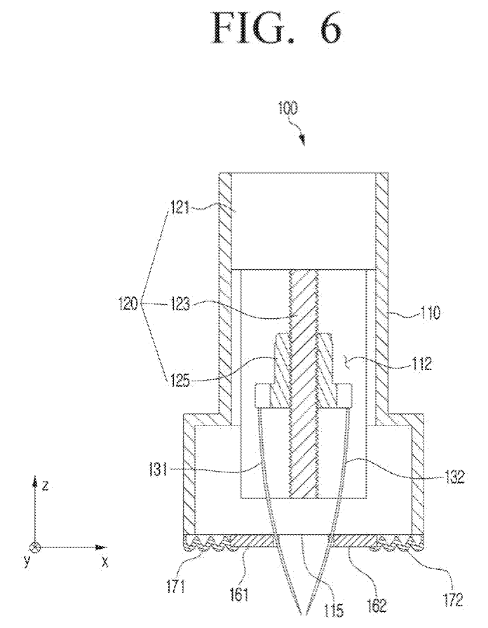

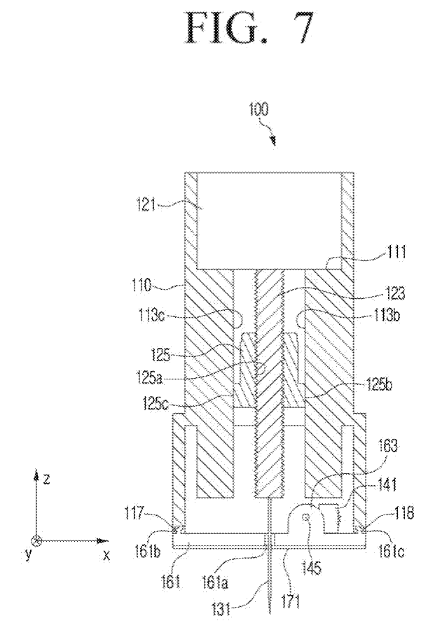

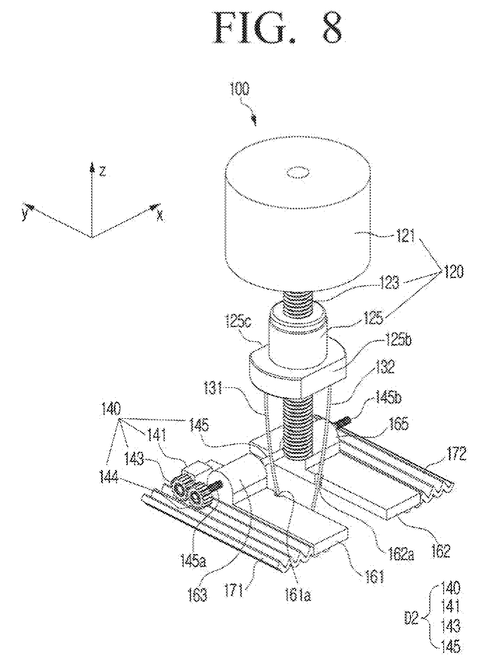

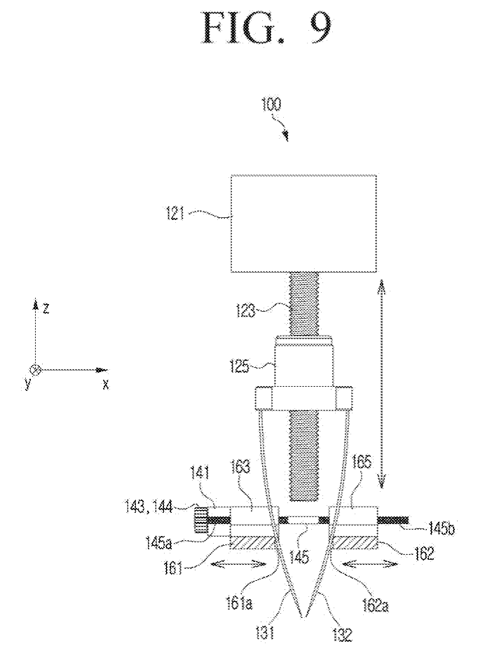

FIG. 4 is a perspective view showing the gripper according to an embodiment of the present disclosure; FIG. 5 is a bottom view showing the gripper according to an embodiment of the present disclosure; FIGS. 6 and 7 are cross-sectional views taken along lines A-A’ and line B-B’ shown in FIG. 5, respectively; FIG. 8 is a perspective view showing the inside of the gripper according to an embodiment of the present disclosure; and FIG. 9 is a side view showing the gripper shown in FIG. 8.

Referring to FIGS. 4 to 7, the gripper 100 according to an embodiment may include a housing 110, a first driving part 120, the first needle 131, the second needle 132, a second driving part 140, a first adjustment block 161, and a second adjustment block 162.

According to an embodiment, the housing 110 may include an accommodation space 112 in which the first driving part 120 is disposed. An opening 115 may be provided at a lower end of the housing 110. The second driving part 140 may be disposed in the opening 115 in the housing 110. A coupling groove 111 may be provided on the upper part of the housing 110, which is coupled to the first driving motor 121.

According to an embodiment, the first driving part 120 may move the first needle 131 and the second needle 132 in a first direction (e.g., from the upper to lower sides of the housing 110 along a z-axis, as shown in FIG. 6) or a second direction opposite to the first direction. The first driving part 120 may include the first driving motor 121 capable of rotating forward or backward, a screw shaft 123 connected to the first driving motor 121 to be rotated forward or backward by driving the first driving motor 121, and a movable nut 125 coupled to the screw shaft 123. A plurality of balls may be disposed between the screw shaft 123 and the movable nut 125. For example, the plurality of balls may be arranged along a circumferential direction of the screw shaft. Therefore, the screw shaft 123 and the movable nut 125 may form a ball screw structure.

According to an embodiment, the movable nut 125 may include a fastening hole 125a screw-coupled to the screw shaft 123. The movable nut 125 may include a first contact surface 125b disposed on one side and a second contact surface 125c disposed on a side opposite to the first contact surface 125b. The first contact surface 125b and the second contact surface 125c may be planes and may be parallel to each other. The first contact surface 125b and the second contact surface 125c may respectively be slidably brought into contact with a first guide wall 113b and a second guide wall 113c, forming the accommodation space 112 of the housing 110.

For example, the movable nut 125 may move along the screw shaft 123 in the first direction if the screw shaft 123 rotates forward by driving the first driving motor 121. Conversely, the movable nut 125 may move along the screw shaft 123 in the second direction if the screw shaft 123 rotates backward by the operation of the first driving motor 121. If the movable nut 125 moves in the first direction or the second direction, the first and second contact surfaces 125b or 125c may interfere with the first or second guide wall 113b or 113c of the housing 110, thus making the movable nut 125 move in a straight line along the screw shaft 123 without rotating.

According to an embodiment, each of the first needle 131 and the second needle 132 may have its upper end connected to a lower end of the movable nut 125. The first needle 131 and the second needle 132 may move in the first direction or the second direction together with the movable nut 125 by driving the first driving motor 121, thereby allowing their access to the accommodation space 112 in the housing 110 through the opening 115 in the housing 110. For example, the first needle 131 and the second needle 132 may move outward from the housing 110 by passing through the opening 115 in the housing 110 by operation of the first driving part 120 while being disposed in the accommodation space 112 of the housing 110, and conversely, may move into the accommodation space 112 of the housing 110 by passing through the opening 115 in the housing 110 while being disposed outside the housing 110.

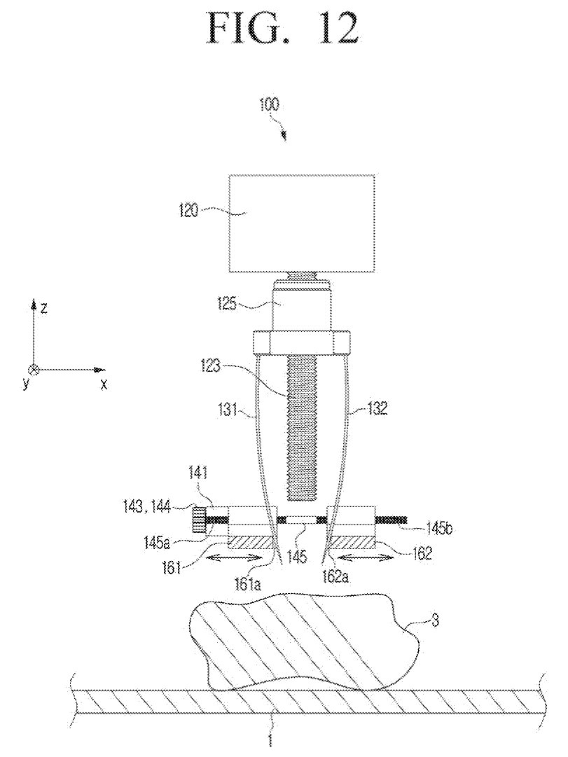

According to an embodiment, the first needle 131 and the second needle 132 may be disposed to face each other. For example, as shown in FIG. 5, a virtual first straight line 131a passing through a center of the first needle 131 may be parallel to a virtual second straight line 132a passing through a center of the second needle 132. In this case, the virtual first straight line 131a of the first needle 131 may have an offset distance L with respect to the virtual second straight line 132a of the second needle 132. For example, the offset distance L may refer to a distance by which the first needle 131 and the second needle 132 may intersect without coming into contact with each other if bent to face each other. Accordingly, the first needle 131 and the second needle 132 may intersect without interfering with each other in case of gripping the item 3 (see FIG. 12). For example, the manner in which the first needle 131 and the second needle 132 grip the item 3 may be implemented as a form in which a tip of the first needle 131 and a tip of the second needle 132 are inserted into the item 3 to a depth where the first needle 131 and the second needle 132 intersect from both sides of the item 3.

According to an embodiment, the first needle 131 may have a curved shape bent toward the second needle 132 from its upper to lower ends. The second needle 132 may have a curved shape bent toward the first needle 131 from its upper to lower ends. A curvature of the first needle 131 and a curvature of the second needle 132 may be substantially the same as each other. A length of the first needle 131 and a length of the second needle 132 may be substantially the same as each other.

According to an embodiment, each of the first needle 131 and the second needle 132 may include an elastic material. For example, the first needle 131 may have an elastic force applied toward the first adjustment block 161. The second needle 132 may have an elastic force applied toward the second adjustment block 162. Accordingly, the first needle 131 and the second needle 132 may be in elastic contact with the first adjustment block 161 and the second adjustment block 162, respectively.

Referring to FIGS. 8 and 9, the second driving part 140 according to an embodiment may adjust the spacing between the first needle 131 and the second needle 132. For example, the second driving part 140 may move the first adjustment block 161 and the second adjustment block 162 toward each other along an x-axis shown in FIG. 9. Conversely, the second driving part 140 may move the first adjustment block 161 and the second adjustment block 162 farther away from each other along the x-axis shown in FIG. 9.

According to an embodiment, the second driving part 140 may include the second driving motor 141 capable of rotating forward or backward, a driving gear 143 connected to the second driving motor 141 to rotate forward or backward by driving the second driving motor 141, a driven gear 144 connected to the driving gear 143, and a rotation shaft 145 having one end connected to the driven gear 144.

According to an embodiment, the rotation shaft 145 of the second driving part 140 may be approximately perpendicular to the screw shaft 123 of the first driving part 120. The rotation shaft 145 may pass through a first shaft coupling part 163 disposed on the top of the first adjustment block 161 and a second shaft coupling part 165 disposed on the top of the second adjustment block 162. In this case, the rotation shaft 145 may include a first screw part 145a adjacent to the driven gear 144 and a second screw part 145b disposed farther from the driven gear 144 than the first screw part 145a.

For example, the first screw part 145a may be screw-coupled to the first shaft coupling part 163 of the first adjustment block 161. The second screw part 145b may be screw-coupled to the second shaft coupling part 165 of the second adjustment block 162. For example, the first screw part 145a and the second screw part 145b may have opposite helical directions. For example, if the first screw part 145a has a left-hand helical direction, the second screw part 145b may have a right-hand helical direction. Accordingly, if the rotation shaft 145 rotates forward, the first adjustment block 161 and the second adjustment block 162 may move toward each other. Conversely, if the rotation shaft 145 rotates backward, the first adjustment block 161 and the second adjustment block 162 may move farther away from each other.

According to an embodiment, the first adjustment block 161 and the second adjustment block 162 may be disposed in the opening 115 in the housing 110, as shown in FIG. 6. The first adjustment block 161 may include a first rail 161b and a second rail 161c, capable of being slidably inserted into a first guide groove 117 and a second guide groove 118, respectively, formed at a lower end of the housing 110 along a y-axis shown in FIG. 7. The second adjustment block 162 may have a structure similar to that of the first adjustment block 161. Accordingly, the first adjustment block 161 and the second adjustment block 162 may move toward each other or farther away from each other while being slidably coupled to the lower end of the housing 110 by power provided by the second driving part 140.

According to an embodiment, the first adjustment block 161 may include a first accommodation groove 161a formed in a side surface facing the second adjustment block 162 along a z-axis direction shown in FIG. 8. The first needle 131 may be guided by the first accommodation groove 161a and move along the first direction or the second direction. The second adjustment block 162 may include a second accommodation groove 162a formed in a side surface facing the first adjustment block 161 along the z-axis direction shown in FIG. 8. The second needle 132 may be guided by the second accommodation groove 162a and move along the first direction or the second direction. Accordingly, if the first needle 131 and the second needle 132 grip the item 3, the tips of the first needle 131 and the second needle 132 may minimize or suppress bending in an undesirable direction caused by a repulsive force acting on the tips of the first needle 131 and the second needle 132 in a direction opposite to a direction in which the tips stab the item 3.

According to an embodiment, for example, a center of the first accommodation groove 161a in the first adjustment block 161 may be disposed on the virtual first straight line 131a, and a center of the second accommodation groove 162a may be disposed on the virtual second straight line 132a. Accordingly, the center of the first accommodation groove 161a and the center of the second accommodation groove 162a may be spaced apart from each other by the offset distance L.

According to an embodiment, the first adjustment block 161 and the second adjustment block 162 may move toward or farther away from each other by power provided by the second driving part 140 to adjust the spacing between the first needle 131 and the second needle 132. In this case, the first needle 131 may maintain its elastic contact with an inner surface of the first accommodation groove 161a while being accommodated in the first accommodation groove 161a of the first adjustment block 161. The second needle 132 may also maintain its elastic contact with an inner surface of the second accommodation groove 162a while being accommodated in the second accommodation groove 162a of the second adjustment block 162.

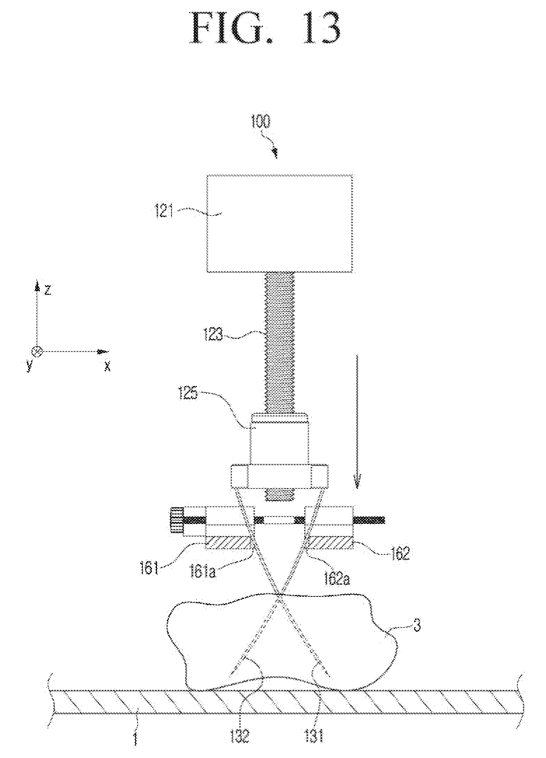

According to an embodiment, if the first needle 131 and the second needle 132 move in the first direction while the spacing therebetween is set based on the driving of the first adjustment block 161 and the second adjustment block 162, the needles may be bent to interfere with the first adjustment block 161 and the second adjustment block 162 and intersect with each other. The item 3 may be stably gripped by the first needle 131 and the second needle 132 that intersect with each other (see FIG. 13). In this way, the first and second needles 131 and 132 of the gripper 100 according to an embodiment may stab and grip the item 3, thereby minimizing a region for gripping the item 3, and gripping the item 3 while having little damage to the item 3.

According to an embodiment, the first adjustment block 161 may be connected to a first corrugated panel 171. The first corrugated panel 171 may have one end connected to the lower end of the housing 110 and the other end connected to the first adjustment block 161. The first corrugated panel 171 may be unfolded or folded as the first adjustment block 161 moves along the lower end of the housing 110. The first corrugated panel 171 may partially cover the opening 115 in the housing 110 while enabling the movement of the first adjustment block 161, thereby preventing a foreign material from flowing into the accommodation space 112 of the housing 110. The second adjustment block 162 may be connected to a second corrugated panel 172. The second corrugated panel 172 may have one end connected to the lower end of the housing 110 and the other end connected to the second adjustment block 162. The second corrugated panel 172 may be approximately symmetric to the first corrugated panel 171.

Hereinafter, a control method of the robot apparatus 10 according to an embodiment is described to grip the item 3 from the container 1, transport the gripped item 3 to the target container 9a, and then drop the transported item 3 into the target container 9a.

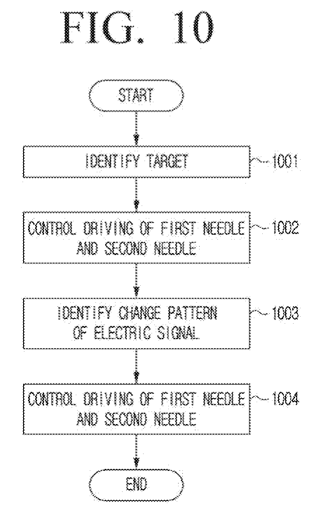

FIG. 10 is a flowchart schematically showing the control method of a robot apparatus according to an embodiment of the present disclosure.

According to an embodiment, the image sensor 30 (see FIG. 1) may capture an image of the item 3 (see FIG. 2) (hereinafter, referred to as the “target 3”) included in the container 1 (see FIG. 2). The captured image may be stored in the memory 210 (see FIG. 1). The processor 230 (see FIG. 1) may identify the target based on an obtained image (see 1001 in FIG. 10).

According to an embodiment, the processor 230 may control the driving of the first needle 131 (see FIG. 4) and the second needle 132 (see FIG. 4) included in the gripper 100 (see FIG. 4) by controlling the first driving motor 121 to grip the identified target 3 (see 1002 in FIG. 10).

According to an embodiment, the processor 230 may identify the change pattern of the electric signal (e.g., the current value) corresponding to the load applied to the first driving motor 121 that drives the first needle 131 and the second needle 132 during a process of gripping the target 3 by using the first needle 131 and the second needle 132 (see 1003 in FIG. 10).

According to an embodiment, if the reference signal pattern stored in the memory 210 and the identified change pattern of the electric signal do not match each other, the processor 230 may control the first driving motor to move the first needle 131 and the second needle 132 to their initial positions to grip the target 3 again (see 1004 in FIG. 10).

Hereinafter, the control method of a robot apparatus according to an embodiment of the present disclosure is described in detail with reference to the drawings.

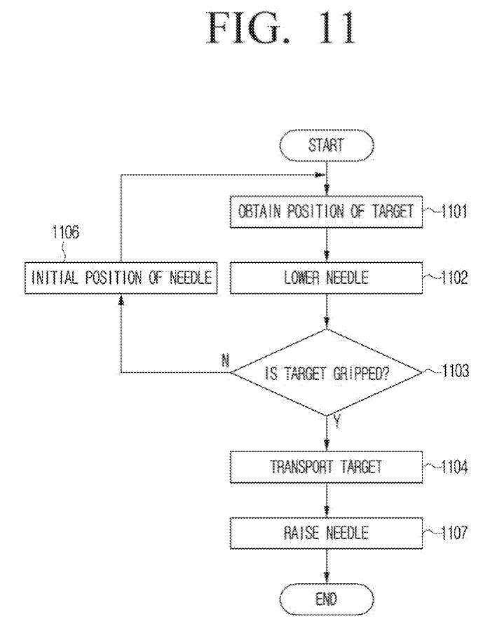

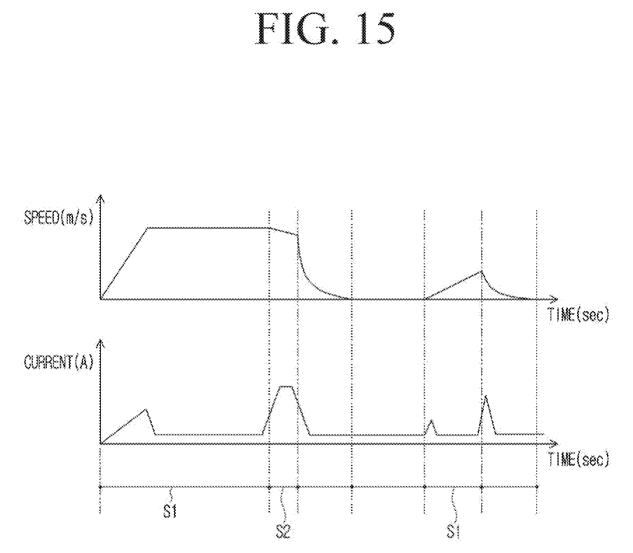

FIG. 11 is a flowchart showing the control method of a robot apparatus according to an embodiment of the present disclosure; FIGS. 12, 13, and FIG. 14 are diagrams showing examples of controlling the gripper of the robot apparatus according to an embodiment of the present disclosure to grip the item from the container and drop the item into the target container; and FIG. 15 is a graph showing a change in a movement speed of the needle and a change in a current according to a control operation of the robot apparatus according to an embodiment of the present disclosure.

According to an embodiment, the processor 230 may control the image sensor 30 (see FIG. 1) to obtain the image information of the plurality of items contained in the container 1 (see FIG. 2). For example, the image information may be the image information including the position coordinates, size, shape, or the like of each of the plurality of items. Here, the position coordinates may be three-dimensional coordinates corresponding to the center of each of the items 3. The processor 230 may control the image information obtained from the image sensor 30 to be stored in the memory 210. The processor 230 may obtain a position of the target 3 based on the image information (see 1101 in FIG. 11).

According to an embodiment, the processor 230 may control the first driving motor 121 to move the first needle 131 and the second needle 132 to their initial positions (see FIG. 12). The processor 230 may obtain a distance from the tips of the first needle 131 and the second needle 132 disposed at the initial positions to a surface of the target 3 based on the image information. The processor 230 may obtain a depth at which the first needle 131 and the second needle 132 are inserted into the target 3 based on the image information and the characteristic information of the item (e.g., the stiffness, density, texture, or the like of the material included in the item) stored in the memory 210.

According to an embodiment, the processor 230 may control the second driving motor 141 to set the spacing between the first needle 131 and the second needle 132 that corresponds to a size of the target 3 based on the image information.

According to an embodiment, the processor 230 may control the first driving motor 121 to lower the first needle 131 and the second needle 132 by a distance equal to the sum of the distance from the tips of the first needle 131 and the second needle 132 to the surface of the target 3 and the depth at which the first needle 131 and the second needle 132 are inserted into the target 3 (see 1102 in FIG. 11).

According to an embodiment, the processor 230 may control the first driving motor 121 to move the first needle 131 and the second needle 132 at a first speed until the surface of the target 3 while the first needle 131 and the second needle 132 are lowered, and at a second speed slower than the first speed while the first needle 131 and the second needle 132 are inserted into the target 3 from the surface of the target 3. Referring to FIG. 15, in a needle lowering section (S1), the first needle 131 and the second needle 132 may move at a fast speed (i.e., the first speed) before gripping the target 3, and in a gripping section (S2), the first needle 131 and the second needle 132 may move at a slow speed (i.e., the second speed) to minimize shaking of the target 3 while the first needle 131 and the second needle 132 are inserted into the target 3. Accordingly, the control method of a robot apparatus 10 according to an embodiment of the present disclosure may shorten a time for gripping the target 3 and stably grip the target 3. Referring to FIG. 13, the first needle 131 and the second needle 132 may be inserted into the target 3 and disposed to intersect with each other. Accordingly, the target 3 may be stably gripped by using the first needle 131 and the second needle 132.

According to an embodiment, the load may be applied to the first driving motor 121 based on characteristic information of the target 3 (e.g., the stiffness and density of the material included in the item) during a time in which the first needle 131 and the second needle 132 are inserted into the target 3 (e.g., less than about one second or about one to two seconds). In this way, the current value in the gripping section (S2) may be greater than the average current value in the needle lowering section (S1). The processor 230 may obtain whether or not the target is gripped by comparing the change pattern of the electric signal (e.g., the current value) corresponding to the load applied to the first driving motor 121 with the reference signal pattern stored in the memory 210 during the process in which the first needle 131 and the second needle 132 grip the target 3 (see 1103 in FIG. 11).

According to an embodiment, the processor 230 may control the robot arm 20 to transport the target 3 to the predetermined position (see 1104 in FIG. 11), for example, the predetermined position in the target container 9a (see FIG. 3), together with the gripper 100, if the reference signal pattern stored in the memory 210 and the identified change pattern of the electric signal match each other. Conversely, the processor 230 may control the first driving motor 121 to move the first needle 131 and the second needle 132 to their initial positions to grip the target 3 again if the reference signal pattern stored in the memory 210 and the identified change pattern of the electric signal do not match with each other (see 1106 in FIG. 11).

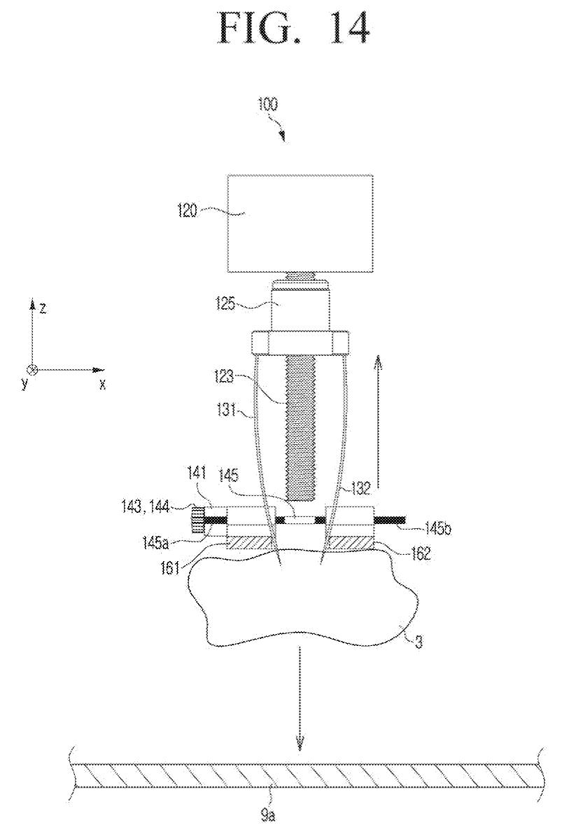

According to an embodiment, the processor 230 may control the first driving motor 121 to raise the first needle 131 and the second needle 132 to drop the target 3 into the target container 9a while the gripper 100 is transported to the predetermined position above the target container 9a (see 1107 in FIG. 11). For example, the first needle 131 and the second needle 132 may rise together with the target 3 as shown in FIG. 14. The target 3 is unable to rise because the target 3 interferes with a lower surface of the first adjustment block 161 or the second adjustment block 162. The first needle 131 and the second needle 132 may be raised further and gradually drawn out from the inside of the target 3. The target 3 may be dropped into the target container 9a by its own weight as the gripping state using the first needle 131 and the second needle 132 is almost released.

The robot apparatus 10 according to an embodiment may repeatedly perform the above process to transport another target 3 in the container 1 to the target container 9b (see FIG. 3).

The robot apparatus 10 according to an embodiment may control the first needle 131 and the second needle 132 to an optimal state for gripping the item in response to a type of the item. Accordingly, the gripper 100 may accurately grip the target 3 in the container 1 by using the first needle 131 and the second needle 132 and stably drop the target 3 into the target container 9b.

A method according to one or more embodiments may be implemented in the form of program commands that may be executed through various computer devices and recorded in a computer-readable medium. The computer-readable medium may include a program command, a data file, and a data structure alone or in combination. The program commands recorded in the medium may be those specifically designed and configured for the disclosure or may be known and available to those of skill in the art of computer software. Examples of a computer readable recording medium include magnetic media such as hard disks, floppy disks and magnetic tapes, optical media such as CD-ROMs and DVDs, magneto-optical media such as floptical disks, or hardware devices such as ROMs, RAMs and flash memories, which are specially configured to store and execute program commands. Examples of the program commands include a machine language code generated by a compiler and a high-level language code executable by a computer using an interpreter and the like.

One or more embodiments may also be implemented in the form of a recording medium containing computer-executable instructions, such as program modules executed by a computer. Computer-readable media may be any available media that are to be accessed by a computer, and includes both volatile and nonvolatile media, removable and non-removable media. Computer-readable media may include both computer storage media and communication media. Computer storage media includes both volatile and nonvolatile, removable and non-removable media implemented in any method or technology for storage of information such as computer-readable instructions, data structures, program modules or other data. Communication media typically includes computer readable instructions, data structures, program modules, or other data in a modulated data signal such as a carrier wave, or other transport mechanism, and includes any information delivery media. One or more embodiments may also be implemented as a computer program or computer program product including computer-executable instructions, such as a computer program executed by a computer.

The device-readable storage medium may be provided in the form of a non-transitory storage medium. Here, the term “non-transitory storage medium” simply means a tangible device that does not contain signals (e.g. electromagnetic waves), and the term does not distinguish between cases in which data is stored semi-permanently or temporarily on a storage medium. For example, the “non-transitory storage medium” may include a buffer in which data is temporarily stored.

According to one or more embodiments, the methods according to one or more embodiments disclosed herein may be provided as included in a computer program product. The computer program product may be traded between sellers and buyers as commodities. The computer program product may be distributed in the form of a device-readable storage medium (e.g., a compact disc read only memory (CD-ROM)), or may be distributed online (e.g., by download or upload) via an application store or directly between two user devices (e.g., smartphones). In the case of online distribution, at least a portion of the computer program product (e.g., a downloadable app) may be temporarily stored or temporarily generated in a device-readable storage medium, such as the memory of a server of a manufacturer, a server of an application store, or an intermediary server.

Hereinabove, although the embodiments are described with reference to the specific drawings, the present disclosure may be variously modified and changed from the above description by those skilled in the art to which the present disclosure pertains. For example, an appropriate result may be achieved even if the described techniques are performed in a order different from that of the described method, and/or the described technologies are performed in a different order than the described method, and/or the components such as the described system, structure, device, circuit and the like are coupled or combined to each other in a form different from that of the described method, or the components are replaced or substituted by other components or equivalents. Therefore, other implementations, other embodiments and those equivalent to the claims also fall within the scope of the claims to be described below.

What is claimed is:

1. A gripper comprising:
a housing;
a first driving part and a second driving part both inside the housing;
a first needle and a second needle both configured to move in a first direction through an opening in the housing from the inside of the housing to an outside of the housing, , or to move from the outside of the housing to the inside of the housing in a second direction opposite to the first direction, based on an operation of the first driving part; and
a first adjustment block and a second adjustment block, both in the opening of the housing and both configured to move toward each other or away from each other based on an operation of the second driving part,
wherein the first needle and the second needle are curved toward one another and are configured to grip an item by intersecting with each other as the first needle and the second needle interfere with the first adjustment block and the second adjustment block as the first driving part causes the first needle and the second needle to move in the first direction.

2. The gripper of claim 1, wherein the first driving part comprises:
a first driving motor;
a screw shaft connected to the first driving motor and configured to rotate in a first rotational direction or a second rotational direction by an operation of the first driving motor; and
a movable nut screw-coupled to the screw shaft and configured to move in the first direction based on the screw shaft rotating in the first rotational direction and to move in the second direction based on the screw shaft rotating in the second rotational direction, and
wherein the movable nut is configured to be guided by a guide hole inside the housing and to move in the first direction or the second direction without rotating.

3. The gripper of claim 2, wherein each of the first needle and the second needle comprises a first end fixed to the movable nut and configured to move together with the movable nut in the first direction or the second direction.

4. The gripper of claim 3, wherein a virtual first straight line passing through a center of the first needle is parallel to a virtual second straight line passing through a center of the second needle and has an offset distance with respect to the virtual second straight line.

5. The gripper of claim 1, wherein the first adjustment block comprises a first accommodation groove formed in a side surface facing the second adjustment block, the first accommodation groove configured to guide a portion of the first needle as the first needle moves in the first direction or the second direction, and
wherein the second adjustment block comprises a second accommodation groove formed in a side surface facing the first adjustment block, the second accommodation groove configured to guide a portion of the second needle as the second needle moves in the first direction or the second direction.

6. The gripper of claim 5, wherein the first accommodation groove and the second accommodation groove are offset from each other.

7. The gripper of claim 1, further comprising:
a first corrugated panel connected to the first adjustment block and a lower end of the housing, wherein the first corrugated panel is configured to enable movement of the first adjustment block; and
a second corrugated panel connected to the second adjustment block and the lower end of the housing, wherein the second corrugated panel is configured to enable movement of the second adjustment block.

8. The gripper of claim 1, wherein a length of the first needle is the same as a length of the second needle.

9. The gripper of claim 8, wherein the first needle is bent toward the second needle at a first curvature, and
wherein the second needle is bent toward the first needle at a second curvature.

10. The gripper of claim 1, wherein each of the first needle and the second needle comprises an elastic material.

11. A robot apparatus comprising:
a robot arm comprising a plurality of joints;
a gripper comprising a first driving motor, a first needle, and a second needle, wherein the first needle and the second needle are each connected to an end of the robot arm and are curved toward each other;
an image sensor configured to obtain an image of a target contained in a container;
memory storing at least one instruction and further storing information on a reference signal pattern corresponding to a target gripping process; and
at least one processor configured to individually or collectively execute the at least one instruction,
wherein the at least one instruction, when executed by the at least one processor individually or collectively, causes the robot apparatus to:
identify the target to be gripped based on the image,
control the gripper to grip the identified target using the first needle and the second needle by controlling the first driving motor to cause the first needle and the second needle to move in a first direction from an inside of the gripper toward an outside of the gripper, and
based on a change pattern of an electrical signal corresponding to a load applied to the first driving motor during the target gripping process not matching the reference signal pattern, control the gripper to grip the identified target again by controlling the first driving motor to cause the first needle and the second needle to move in a second direction from the outside of the gripper toward the inside of the gripper, and then controlling the first driving motor to cause the first needle and the second needle to move in the first direction from the inside of the gripper toward the outside of the gripper.

12. The robot apparatus of claim 11, wherein the gripper further comprises:
a housing;
a first driving part inside the housing and including the first driving motor;
a second driving part inside the housing and including a second driving motor; and
a first adjustment block and a second adjustment block disposed in an opening in the housing and facing each other,
wherein the first needle and the second needle are configured to move through the opening in the housing in the first direction or the second direction based on an operation of the first driving motor, and
wherein the first needle and the second needle are configured to grip the identified target by intersecting with each other as the first needle and the second needle interfere with the first adjustment block and the second adjustment block as the first driving part causes the first needle and the second needle to move in the first direction.

13. The robot apparatus of claim 12, wherein the first driving part further comprises:
a screw shaft connected to the first driving motor and configured to rotate in a first direction or a second direction by an operation of the first driving motor; and
a movable nut screw-coupled to the screw shaft and configured to move in the first direction based on the screw shaft rotating in the first direction and to move in the second direction based on the screw shaft rotating in the second direction, and
wherein the movable nut is configured to be guided by a guide hole inside the housing and to move in the first direction or the second direction without rotating.

14. The robot apparatus of claim 11, wherein a virtual first straight line passing through a center of the first needle is parallel to a virtual second straight line passing through a center of the second needle and has an offset distance with respect to the virtual second straight line.

15. The robot apparatus of claim 12, wherein the first adjustment block comprises a first accommodation groove formed in a side surface facing the second adjustment block, the first accommodation groove configured to guide a portion of the first needle as the first needle moves in the first direction or the second direction, and
wherein the second adjustment block comprises a second accommodation groove formed in a side surface facing the first adjustment block, the second accommodation groove configured to guide a portion of the second needle as the second needle moves in the first direction or the second direction.

16. The robot apparatus of claim 13, wherein each of the first needle and the second needle comprises a first end fixed to the movable nut and configured to move together with the movable nut in the first direction or the second direction.

17. A method of controlling a robot apparatus including a gripper, the method comprising:
identifying a target based on an image of the target;
controlling a first needle included in the gripper and a second needle included in the gripper to grip the identified target;
identifying a change pattern of an electrical signal corresponding to a load applied to a driving motor of the gripper during the driving of the first needle and the second needle, wherein the driving motor drives the first needle and the second needle; and
based on a previously stored reference signal pattern and the identified change pattern of the electrical signal not matching, controlling the first needle and the second needle to grip the target again.

18. The method of claim 17, further comprising:
controlling the gripper to move the identified target to a predetermined drop position; and
controlling the first needle and the second needle to separate the identified target from the first needle and the second needle.

19. The method of claim 17, further comprising, prior to gripping the identified target:
identifying a size of the identified target based on the image; and
adjusting a spacing between the first needle and the second needle based on the size of the target.

20. A non-transitory computer readable medium having instructions stored therein, which when executed by at least one processor individually or collective, cause the at least one processor individually or collectively to execute a method of controlling a robot apparatus including a gripper, the method comprising:
identifying a target based on an image of the target;
controlling a first needle included in the gripper and a second needle included in the gripper to grip the identified target;
identifying a change pattern of an electrical signal corresponding to a load applied to a driving motor of the gripper during the driving of the first needle and the second needle, wherein the driving motor drives the first needle and the second needle; and
based on a previously stored reference signal pattern and the identified change pattern of the electrical signal not matching, controlling the first needle and the second needle to grip the target again.
